(19) United States
(12) Patent Application Publication
(10) Pub. No.: US 2006/0170288 A1
(43) Pub. Date: Aug. 3, 2006

(54) Resonant DC-DC converter of multi-output type

(75) Inventor: Hiroshi Usui, Niiza-shi (JP)

Correspondence Address: BACHMAN & LAPOINTE, P.C., 900 CHAPEL STREET, SUITE 1201, NEW HAVEN, CT, 06510, US

(73) Assignee: Sanken Electric Co., Ltd.

(21) Appl. No.: 11/339,967

(22) Filed: Jan. 25, 2006

(30) Foreign Application Priority Data
Jan. 28, 2005 (JP) 2005-20916

(51) Int. Cl. H02J 3/00

(52) U.S. Cl. 307/17

(57) ABSTRACT

A DC-DC converter of multi-output type is provided wherein first and second MOS-FETs 1 and 2 are alternately turned on and off to take a plurality of DC outputs out of a plurality of secondary windings 4b, 4c and 4d of a transformer 4 through related rectifying smoothers 12, 22 and 32. A first DC output from first secondary winding 4b is controlled by adjusting a duty ratio of first and second MOS-FETs 1 and 2. At least one magnetic amplifier 21, 31 is connected in series between each of second or more secondary windings 4c and 4d and related rectifying smoother 22 and 32 to adjust reset current to the magnetic amplifier 21, 31, thereby generating stabilized DC-outputs V_{O2} and V_{O3} from the second or more secondary windings 4c, 4d.

### TECHNICAL FIELD

This invention relates to a DC-DC converter, in particular, a resonant DC-DC converter of multi-output type capable of producing stabilized DC output powers.

### BACKGROUND OF THE INVENTION

FIG. 1 shows a prior art DC-DC converter of forward type which comprises a MOS-FET 51 as a switching element connected in series to a DC power source 53 and a primary winding 54a of a transformer 54; a control circuit 68 for supplying drive signals to a control or gate terminal of MOS-FET 51, a first rectifying smoother 60 connected to a first secondary winding 54b of transformer 54; and a second rectifying smoother 70 connected to a second secondary winding 54c of transformer 54. A parasitic diode 52 is connected in parallel to MOS-FET 51 which also is connected in parallel to a series circuit of a resistor 55 and a capacitor 59. Another series circuit of a rectifying diode 58 and a resistor 56 is connected in parallel to primary winding 54a, and a capacitor 57 is connected in parallel to resistor 56.

First rectifying smoother 60 comprises two rectifying diodes 61 and 63 each connected to the opposite ends of first secondary winding 54b; a choke coil or reactor 62 between each cathode terminal of rectifying diodes 61 and 63 and a first positive output terminal 66; and a smoothing capacitor 64 connected between first positive and negative output terminals 66 and 67. A first output voltage detector 65 senses a first output voltage between first positive output terminals 66 and 67 to produce a first error signal to a light emitting diode 69a of a photo-coupler 69. Error signal from first output voltage detector 65 is the electric current equivalent to the differential voltage between a level of first output voltage and a reference voltage of a first normal power source not shown so that light emitting diode 69a is turned on by first error signal. Light from light emitting diode 69a is received by a light receiving or photo-transistor 69b of photo-coupler 69 connected to control circuit 68 which shortens and expands the on-span of MOS-FET 51 for pulse width modulation (PWM) of MOS-FET 51 to stabilize first output voltage to a predetermined level when it is respectively high and low relative to the predetermined level.

Connected to one end of second secondary winding 54c through a saturable reactor 79 is second rectifying smoother 70 which comprises two rectifying diodes 71 and 73 one connected to one end of second secondary winding 54c through saturable reactor 79 and the other connected to the other end of second secondary winding 54c; a choke-coil or reactor 72 connected between each cathode terminal of rectifying diodes 71 and 73 and a second positive output terminal 76; and a smoothing capacitor 74 connected between second positive and negative output terminals 76 and 77. A second output voltage detector 75 senses a second output voltage between second positive and negative output terminals 76 and 77 to produce a second error signal, the electric current equivalent to the differential voltage between a level of second output voltage and a reference voltage of a second normal power source not shown. Second error signal is conveyed from second output voltage detector 75 through a diode 78 to saturable reactor 79 so that second error signal provides a reset signal for saturable reactor 79 to control a conduction angle of reactor 79 and thereby to stabilize second output voltage.

FIG. 2 is a circuit diagram of another prior art DC-DC converter disclosed in Japanese Patent Disclosure No. 2002-247854 published Aug. 30, 2002. The converter shown in FIG. 2 comprises a series circuit of a DC power source 3, a first MOS-FET 1, a primary winding 4a of a transformer 4 and a first capacitor 5; a second capacitor 80 connected in parallel to primary winding 4a and first capacitor 5; a second MOS-FET 2 connected in parallel to second capacitor 80 and between first MOS-FET 1 and DC power source 3; an oscillation circuit 81 connected to each gate terminal of first and second MOS-FETs 1 and 2; a first output series circuit of a saturable reactor 82a, a diode 84a and a smoothing capacitor 14a connected between a first secondary winding 4b of transformer 4 and a first positive output terminal; a first output voltage detector 85a connected to first positive output terminal; and a flux control circuit 41a connected to an output terminal of output voltage detector 85a to produce the output to a junction between saturable reactor 82a and diode 84a through a reset diode 83a; a second output series circuit, similarly to first output series circuit, of a saturable reactor 82b, a diode 84b and a smoothing capacitor 14b connected between a second secondary winding 4c of transformer 4 and a second positive output terminal; a second output voltage detector 85b connected to the second positive output terminal; and a flux control circuit 41b connected to an output terminal of second output voltage detector 85b to produce the output to a junction between saturable reactor 82b and diode 84b through a reset diode 83b. In this way, the converter of FIG. 2 has two DC output terminals.

When first MOS-FET 1 is turned on while second MOS-FET 2 is turned off in the converter shown in FIG. 2, a differential voltage between an original voltage of DC power source 3 and discharged voltage in capacitor 5 is applied on primary winding 4a, and simultaneously a voltage proportional to the differential voltage on primary winding 4a is applied on first secondary winding 4b. At this time, saturable reactor 82a is unsaturated to have the high inductance or inpedance value which therefore produces no electric current through diode 84a. When saturable reactor 82a reaches the saturated condition, there is produced an electric current flowing through diode 84a. Produced current, which is determined by a resonance of leakage inductance of transformer 4 and capacitor 5, calmly increases in a sine waveform to electrically charge smoothing capacitor 14a and supplies an electric power to a first load.

Then, when first MOS-FET 1 is turned off while second MOS-FET 2 is turned on, charged voltage in capacitor 5 is applied on primary winding 4a of transformer 4 to apply different voltages proportional to charged voltage in capacitor 5 respectively on first and second secondary windings 4b and 4c. However, as diodes 84a and 84b are kept off, electric powers are supplied to each of first and second loads from smoothing capacitors 14a and 14b. In this case, output voltage detectors 85a and 85b and flux control circuits 41a and 41b serve to control each reset amount of saturable reactors 82a and 82b. Repetition of the foregoing operation allows saturable reactors 82a and 82b to supply stabilized DC electric powers to each load in the insulated condition immune from voltage fluctuation of DC power source 3.

On the other hand, to stabilize DC outputs by magnetic amplifiers, pulses to be supplied to saturable reactors require their pulse width or span enough to control output voltages. In this view, reactors of secondary rectifying smoothers are cut off during the light load period, reducing the time for supplying electric current to the secondary side, and then, used magnetic amplifiers make width of pulses supplied to saturable reactors narrower. Accordingly, DC-DC converter of forward type shown in FIG. 1 is defective in that it cannot supply sufficient electric power to loads during the light load period for the foregoing reason. To overcome this defect, MOS-FET 51 has to be turned on and off with drive signals of a predetermined pulse width applied to gate terminal of MOS-FET 50 to apply typically continuous signals of sufficient pulse width to saturable reactors, and magnetic amplifiers have to be attached to all output lines. An example of this is also shown in the above Japanese publication. Although the resonant converter shown in this Japanese publication can prevent expansion in size of transformer and saturable reactors, it still requires attachment of magnetic amplifiers such as saturable reactors to all output lines.

An object of the present invention is to provide a DC-DC converter of multi-output type which has a plurality of secondary windings and a magnetic rectifier connected to a second or more secondary windings in addition to a first secondary winding to produce stable plural DC outputs from the secondary windings each through an rectifying smoother. Another object of the present invention is to provide a DC-DC converter of multi-output type which comprises a plurality of secondary windings, rectifying smoothers connected to each secondary winding, and a magnetic amplifier connected between each secondary winding and rectifying smoother to adjust a reset current supplied to the magnetic amplifier, and thereby control DC output power from second or more secondary windings. Still another object of the present invention is to provide an efficient DC-DC converter of multi-output type capable of accomplishing the zero current switching during the resonance and the zero voltage switching during the voltage pseudo resonance with involved extremely less noise. A further object of the present invention is to provide a DC-DC converter of multi-output type capable of producing an additional second or further DC output voltages without variation in duty ratio against load fluctuation even under the unload condition.

### SUMMARY OF THE INVENTION

The DC-DC converter of multi-output type according to the present invention, comprises first and second switching elements (1, 2) connected in series to a DC power source (3); a series circuit of a capacitor (5), a current resonance inductance (6) and a primary winding (4a) of a transformer (4) connected in series between a junction of first and second switching elements (1, 2) and DC power source (3); and a control circuit (8) for alternately turning first and second switching elements (1, 2) on and off to produce a plurality of DC outputs from plural secondary windings (4b to 4d) of transformer (4) each through rectifying smoother (12, 22, 32). Duty ratio of first and second switching elements (1, 2) is adjusted to control a first DC output produced from a first secondary winding (4b). Also, at least one magnetic amplifier (21, 31) is connected in series between each of second or more secondary windings and related rectifying smoother (22, 32) to adjust reset current to the magnetic amplifier (21, 31), thereby controlling DC-output from the second or more secondary windings (4c, 4d). The period of producing DC outputs from secondary windings (4b, 4c, 4d) from magnetic energy accumulated in transformer (4) is unchanged and determined by resonance frequency by resonance capacitor (5) and current resonance inductance (6). Accordingly, when first and second switching elements (1, 2) are turned on and off under control based on output level from first primary winding (4b), pulses determined by resonance frequency resulted from resonance capacitor (5) and current resonance inductance (6) are inevitably supplied to the magnetic amplifier (21, 31) connected to second or more secondary windings (4c, 4d) for stabilized control of the magnetic amplifier (21, 31). Thus, the instant invention enables the magnetic amplifier (21, 31) to perform its well-balanced operation to take a stable DC output out of second or more than two secondary windings (4c, 4d).

### BRIEF DESCRIPTION OF THE DRAWINGS

The above-mentioned and other objects and advantages of the present invention will be apparent from the following description in connection with preferred embodiments shown in the accompanying drawings wherein:

FIG. 1 is an electric circuit diagram of a prior art DC-DC converter of multi-output type;

FIG. 2 is an electric circuit diagram of another prior art DC-DC converter of multi-output type;

FIG. 3 is an electric circuit diagram of a DC-DC converter of multi-output type according to the present invention;

FIG. 4 is a detailed electric circuit diagram of a control circuit shown in FIG. 1;

FIG. 5 is a graph indicating a voltage across first MOS-FET, electric current through and voltage across a capacitor in the DC-DC converter of multi-output type shown in FIG. 1 under the low input voltage;

FIG. 6 is a graph indicating a voltage across first MOS-FET, electric current through and voltage across a capacitor in the DC-DC converter of multi-output type shown in FIG. 1 under the high input voltage;

FIG. 7 is a graph indicating a voltage across first MOS-FET, electric current through and voltage across a capacitor in the DC-DC converter of multi-output type shown in FIG. 1 under the light load condition;

FIG. 8 is a graph indicating a voltage across first MOS-FET, electric current through and voltage across a capacitor in the DC-DC converter of multi-output type shown in FIG. 1 under the heavy load condition;

FIG. 9 is a graph indicating electric characteristics in the output voltage to on-duty ratio of first and second MOS-FETs;

FIG. 10 is an electric circuit diagram of a second embodiment according to the present invention; and

FIG. 11 is a time chart of an electric current through the capacitor for comparison with a voltage across second secondary winding, and voltage across and electric current through a first magnetic amplifier.

### BEST MODE FOR CARRYING OUT THE INVENTION

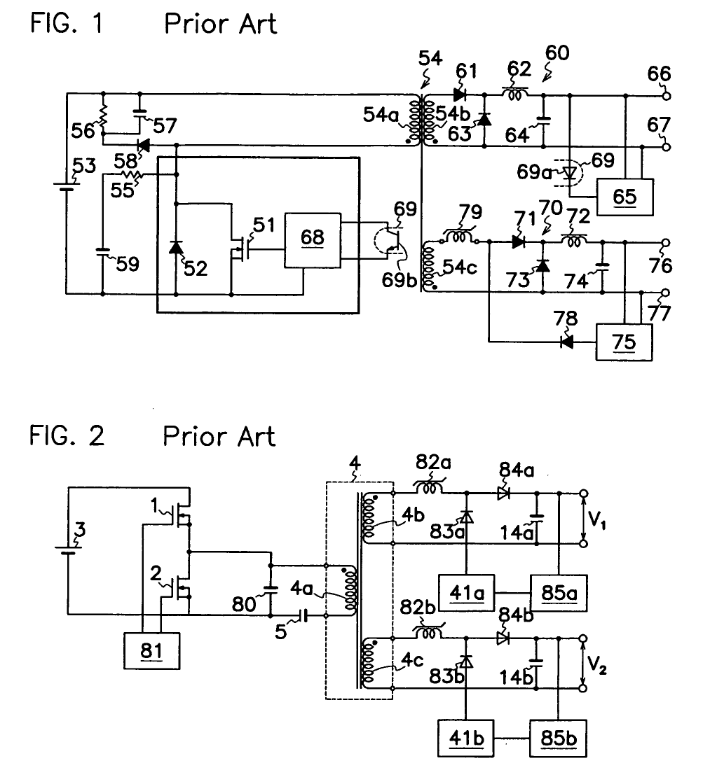

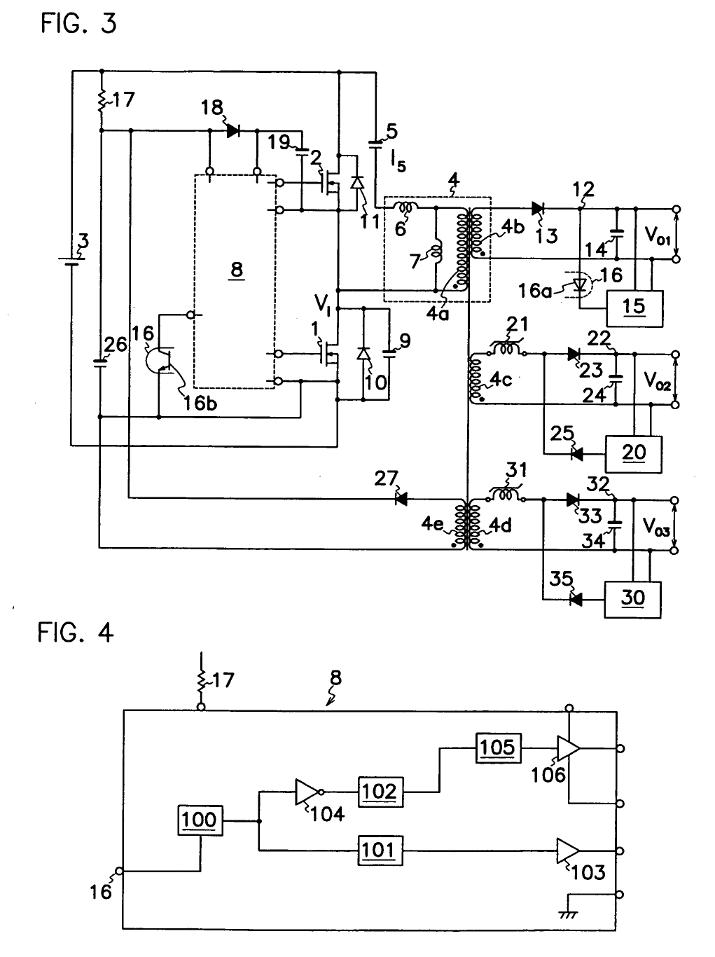

Embodiments of the resonant DC-DC converter of multi-output type according to the present invention will be described hereinafter in connection with FIGS. 3 to 11 of the drawings. Same reference symbols as those shown in FIGS. 1 and 2 are applied to similar portions in these drawings, omitting explanation therefor.

As shown in FIG. 3, the DC-DC converter of multi-output type according to the present invention, comprises first and second MOS-FETs 1 and 2 as first and second switching elements connected in series to a DC power source 3; a series circuit of a capacitor 5, a current resonance inductance 6 and a primary winding 4a of a transformer 4 connected in series between a junction of first and second MOS-FETs 1 and 2 and DC power source 3; an excitation inductance 7 connected in parallel to primary winding 4a of transformer 4; and a control circuit 8 for alternately turning first and second MOS-FETs 1 and 2 on and off. A parasitic capacitor 9 and a parasitic diode 10 are connected in parallel to first MOS-FET 1, and a parasitic diode 11 is connected in parallel to second MOS-FET 2. A smoothing capacitor 26 is electrically charged by electric current from power source 3 through a start-up resistor 17, and when smoothing capacitor 26 is charged at or above a predetermined voltage level, electric power is initially supplied from power source 3 to control circuit 8 which thereby provides drive signals for each control or gate terminal of first and second MOS-FETs 1 and 2. After the converter comes to a steady driving state, electric power is supplied to control circuit 8 from a drive winding 4e of transformer 4 through a rectifying diode 27.

Transformer 4 comprises first, second and third secondary windings 4b, 4c and 4d which are concentrically wound around a common iron core (not shown) together with primary and drive windings 4a and 4e also concentrically wound around the common iron core. First secondary winding 4b is connected through a rectifying diode 13 and smoothing capacitor 14 of a first rectifying smoother 12 to first output terminals to generate a first output voltage V_{O1}. A first voltage detector 15 compares first output voltage V_{O1} with a first reference voltage from a first normal power source not shown to produce a first error signal, the differential voltage between first output voltage V_{O1} and reference voltage so that first error signal provides a first electric current of a value equivalent to the error or differential voltage and passing through a light emitting diode 16a of a photo-coupler 16. Light emitted from light emitting diode 16a is received by a light receiving or photo-transistor 16b to control the oscillation frequency in a oscillation circuit 100 of control circuit 8. Specifically, when first output voltage V_{O1} is higher than reference voltage, control circuit 8 reduces the on-span or on-time of second MOS-FET 2, and adversely, when first output voltage V_{O1} is lower than reference voltage, control circuit 8 extends the on-time of second MOS-FET 2 to adjust output voltage V_{O1} toward a given level.

One end of second secondary winding 4c is connected through a magnetic amplifier 21 to a second rectifying smoother 22 having a rectifying diode 23 and a smoothing capacitor 24 to generate a second output voltage V_{O2} from rectifying smoother 22. A second voltage detector 20 compares second output voltage V_{O2} and a second reference voltage from a second normal power source not shown to produce a second error signal, the differential voltage between second output voltage V_{O2} and second reference voltage so that second error signal provides a second electric current of a value equivalent to the second error or differential voltage, and second electric current is supplied as a reset current to magnetic amplifier 21 through diode 25. Thus, adjustment in degree for resetting magnetic amplifier 21 causes the control of activation or on-time of diode 23 to regulate second output voltage V_{O2} toward a desired level.

One end of third secondary winding 4d is connected through a magnetic amplifier 31 to a third rectifying smoother 32 having a rectifying diode 33 and a smoothing capacitor 34 to generate a third output voltage V_{O3} from third rectifying smoother 32. A third voltage detector 30 compares third output voltage V_{O3} and a third reference voltage from a third normal power source not shown to produce a third error signal, the differential between third output voltage V_{O3} and third reference voltage so that third error signal provides a third electric current of a value equivalent to the third error or differential voltage, and third electric current is supplied as a reset current to magnetic amplifier 31 through diode 35. Thus, adjustment in degree for resetting magnetic amplifier 31 causes the control of activation or on-time of diode 33 to regulate third output voltage V_{O3} toward a desired level.

As shown in FIG. 4 in detail, control circuit 8 comprises an oscillator 100 for generating oscillation signals (PWM signals) of modulated pulse width; a first generator 101 for receiving oscillation signals from oscillator 100 to add a constant dead time to drive signals to gate terminal of MOS-FET 1; a first buffer 103 connected between first generator 101 and gate terminal of MOS-FET 1; a second generator 102 for receiving oscillation signals from oscillator 100 through an inverter 104 to add a constant dead time to drive signals to gate terminal of MOS-FET 2; a level shifter 105 for receiving outputs from second generator 102 to deliver drive signals to gate terminal of second MOS-FET 2 through a second buffer 106. First and second MOS-FETs 1 and 2 are alternately turned on and off with drive signals inclusive of predetermined pauses or dead times added by first and second generators 101 and 102.

In operation of the DC-DC converter shown in FIG. 3, a trigger current flows from DC power source 3 through start-up resistor 17 into smoothing capacitor 26 to electrically charge smoothing capacitor 26. When charged voltage on smoothing capacitor 26 reaches a trigger level for activating control circuit 8, control circuit 8 starts the operation. Then, control circuit 8 alternately turns first and second MOS-FETs 1 and 2 on and off with predetermined intervals or dead times given by outputs from first and second generators 101 and 102 to generate three DC outputs from first to third secondary windings 4b to 4d of transformer 4 through first, second and third rectifying smoothers 12, 22 and 32. When first MOS-FET 1 is turned on by a drive signal from first generator 101 of control circuit 8, a primary winding current runs from DC power source 3 through capacitor 5, current resonance inductance 6, primary winding 4a of transformer 4, excitation inductance 7 and first MOS-FET 1 to DC power source 3. This primary winding current can roughly be classified into four currents, namely an excitation current for transformer 4 and three secondary winding currents each passing through first, second and third secondary windings 4b, 4c and 4d so that the primary winding current is a composite current of excitation and three secondary winding currents. Excitation current forms a resonance current in the sine waveform by current resonance inductance 6, excitation inductance 7 and capacitor 5 with lower resonance frequency than the on-period of first MOS-FET 1, and therefore, excitation current I₅ flowing through capacitor 5 indicates triangular waveforms which involve a sine waveform as a part thereof. Each winding current flowing through first, second and third secondary windings 4b, 4c and 4d indicates a sine resonance current which contains a resonance element by capacitor 5 and current resonance reactor 6 to provide load currents for loads each through first, second and third rectifying smoother 12, 22 and 32.

When first MOS-FET 1 is turned off, magnetic energy stored in transformer 4 induces a voltage pseudo resonance by current resonance inductance 6, excitation inductance 7, capacitor 5 and parasitic capacitor 9. In this case, a resonance voltage appears across first and second MOS-FETs 1 and 2 with the resonance frequency by parasitic capacitor 9 of small capacitance. In other words, when first MOS-FET 1 is turned off, electric current flowing through first MOS-FET 1 is diverted into parasitic capacitor 9, and when parasitic capacitor 9 is charged up to original voltage E of DC power source 3, electric current is further diverted into parasitic diode 11 so that magnetic energy accumulated in transformer 4 is discharged by excitation current flowing through parasitic diode 11. During this period, second MOS-FET 2 can be turned on for the zero voltage switching.

When second MOS-FET 2 is turned on, energy stored in transformer 4 is discharged by electric current diverted from parasitic diode 11 into second MOS-FET 2. Upon completion of the energy release, energy stored in capacitor 5 is discharged by electric current flowing from capacitor 5 through second MOS-FET 2, excitation inductance 7 and current resonance inductance 6 to capacitor 5 to cause excitation current to flow in the adverse polarity to that during the on-period of first MOS-FET 1. This excitation current is a resonance current by capacitor 5 and reactors 6 and 7, but indicates triangular waveforms which involve a sine waveform as a part thereof because the resonance current has the lower resonance frequency than that during the on-period of second MOS-FET 2.

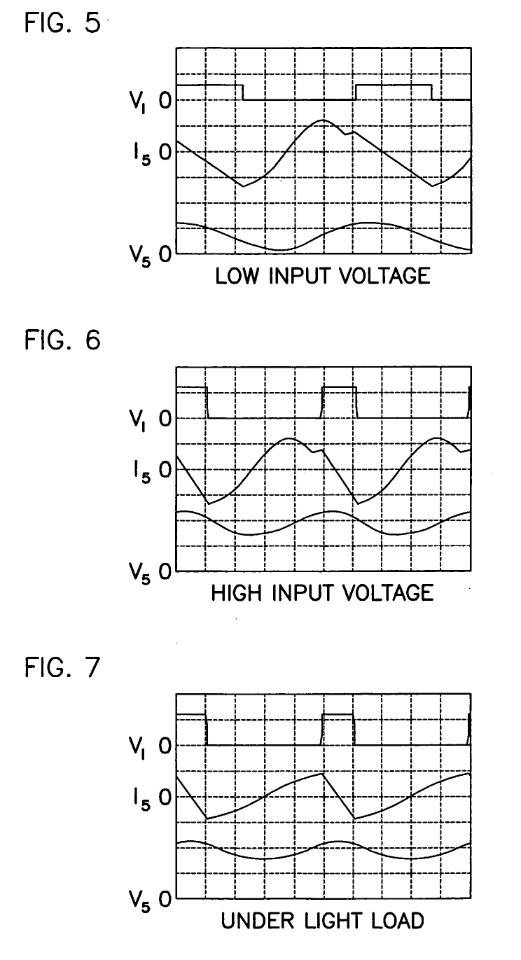

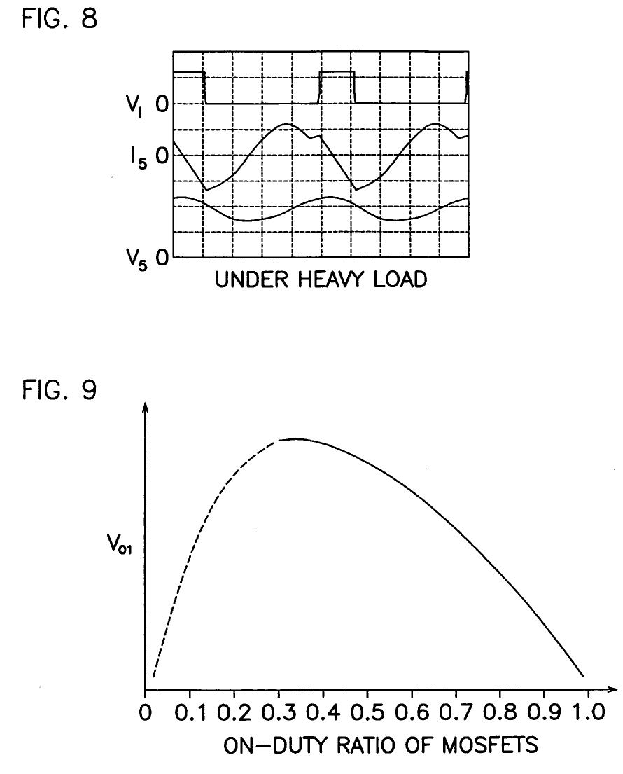

FIGS. 5 to 8 are graphs indicating waveforms of voltage V₁ across first MOS-FET 1, electric current I₅ flowing through capacitor 5 and voltage V₅ across capacitor 5. Both of FIGS. 5 and 6 show variations in current flow I₅ through and voltage V₅ across capacitor 5 with change in voltage V₁ across first MOS-FET 1 under the constant on-period of first MOS-FET 1 and the changed on-period of second MOS-FET 2 under the differently high and low voltages V₁ across first MOS-FET 1 in respectively FIGS. 5 and 6. As understood from FIG. 9, output voltage V_{O1} can be controlled by varying the on-period of second MOS-FET 2 and thereby controlling the duty or on-time ratio of first MOS-FET 1 with change in voltage V₅ across capacitor 5 under the changed voltage V₁ across first MOS-FET 1. FIGS. 7 and 8 show waveforms of voltage V₁ across first MOS-FET 1, current flow I₅ through and voltage V₅ across capacitor 5 respectively during the light and heavy load periods driven with a constant duty or on-period ratio of first MOS-FET 1 under the variation of load. FIG. 7 demonstrates a decreasing resonance current as a load current during the light load period, and FIG. 8 exhibits a moving resonance current corresponding to load current.

FIG. 9 is a graph indicating the variation in output voltage V_{O1} to change in on-duty ratio of first and second MOS-FETs 1 and 2. As understood from FIG. 9, first output voltage V_{O1} can be adjusted by varying the duty ratio of first and second MOS-FETs 1 and 2, modulating charged voltage across capacitor 5 and controlling voltage applied on transformer 4.

First voltage detector 15 senses first output voltage V_{O1} to transmit first error signal to primary control circuit 8 through photo-coupler 16, and control circuit 8 may supply each gate terminal of first and second MOS-FETs 1 and 2 with drive signals (PWM signals) of pulse width modulated based on first error signal to control first output voltage V_{O1} to a constant level. The foregoing embodiment describes an example of PWM wherein the on-period of first MOS-FET 1 is kept constant, and the on-period of second MOS-FET 2 is variable, but other controls can be acquired in manners such as of varying each on-period of first and second MOS-FETs 1 and 2, or controlling pulse width with a fixed frequency.

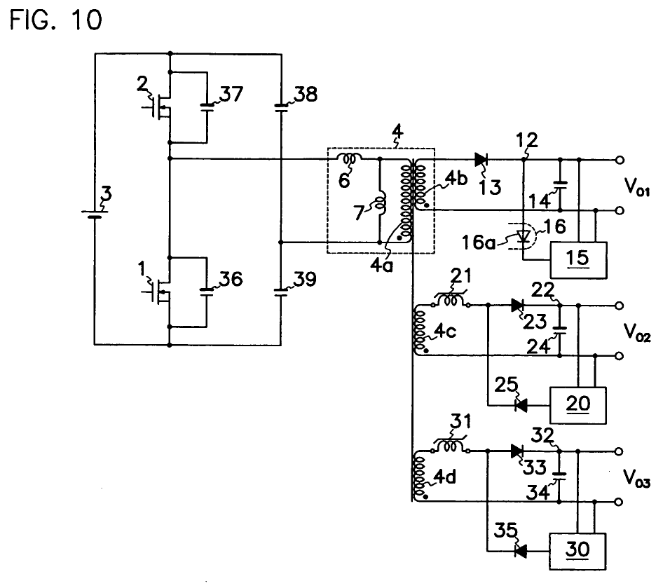

FIG. 10 illustrates an electric circuit diagram of another embodiment according to the present invention which comprises first and second MOS-FETs 1 and 2 as first and second switching elements connected in series to DC power source 3; a first voltage pseudo resonance capacitor 36 connected in parallel to first MOS-FET 1; a second voltage pseudo resonance capacitor 37 connected in parallel to second MOS-FET 2; a series circuit of two current resonance capacitors 38 and 39 connected in parallel to first and second MOS-FETs 1 and 2; a series circuit of a current resonance inductance 6 and primary winding 4a of transformer 4 connected between two junctions of first and second MOS-FETs 1 and 2 and of current resonance capacitors 38 and 39; and an excitation inductance 7 connected in parallel to primary winding 4a of transformer 4. Also, in lieu of leakage inductance in transformer 4, external inductance may be used as current resonance inductance 6.

As mentioned above, the present invention can provide an efficient switching power source capable of achieving the zero-current switching during the current resonance and the zero-voltage switching during the voltage pseudo resonance with extremely less noise. Also, the converter of the invention can generate stabilized second and third output voltages V_{O2} and V_{O3} without change in the duty ratio against fluctuation in load even in case of no load current resulted from first output voltage V_{O1}.

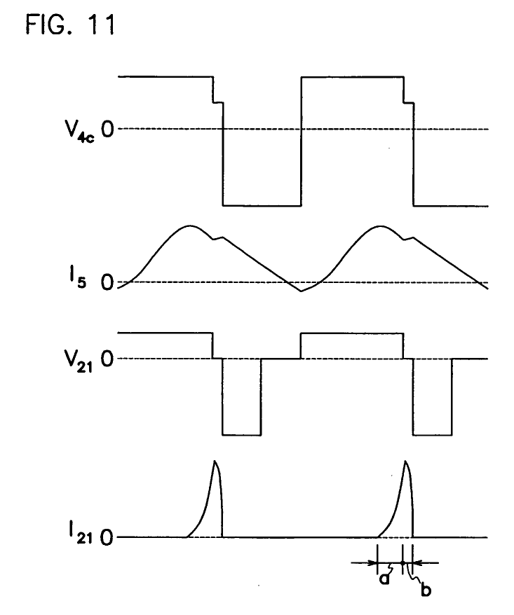

FIG. 11 is a graph indicating a waveform of electric current I₅ flowing through capacitor 5 in comparison with waveforms of voltage V_{4c} applied on second secondary winding 4c, voltage V₂₁ applied on and electric current I₂₁ flowing through first magnetic amplifier 21. A whole period of electric current I₂₁ flowing through first magnetic amplifier 21 includes a first half a of current flow or reset current I₂₁ before complete saturation of first magnetic amplifier 21, and a second half b of current flow I₂₁ after complete saturation of first magnetic amplifier 21. In this way, second and third output voltages V_{O2} and V_{O3} can be controlled by adjusting the period to complete saturation of first magnetic amplifier 21 with the reset current. Also, since first and second magnetic amplifiers 21 and 31 are connected respectively between second secondary winding 4c and second rectifying smoother 22 and between third secondary winding 4d and third rectifying smoother 32, DC outputs from second and third secondary windings 4c and 4d can be controlled by adjusting reset currents respectively toward first and second magnetic amplifiers 21 and 31. The period of producing first, second and third DC outputs from first, second and third secondary windings 4b, 4c and 4d through transformer 4 is unchanged and determined by resonance frequency by resonance capacitor 5 and current resonance inductance 6. Accordingly, when first and second MOS-FETs 1 and 2 are turned on and off under control based on output level from first primary winding 4b, pulses determined by resonance frequency resulted from resonance capacitor 5 and current resonance inductance 6 are inevitably supplied to first and second magnetic amplifiers 21 and 31 connected to second and third secondary windings 4c, 4d for stabilized control of first and second magnetic amplifiers 21 and 31.

Otherwise, unlike the first embodiment shown in FIG. 3 wherein only an excitation current flows through primary winding 4a of transformer 4 during the on-period of second MOS-FET 2, in a further embodiment not shown of the present invention, a load current can flow through third secondary winding 4d during the on-period of second MOS-FET 2 with an inverted polarity of third secondary winding 4d within a range for keeping resonance. Thus, polarity of half-wave rectification may be different between at least one of second or more secondary windings and first secondary winding 4b of transformer 4. In addition, if second secondary winding 4c serves to produce a negative output in place of third secondary winding 4d, both of positive and negative outputs can be taken out of a single secondary winding. A plurality of DC outputs may be produced from first, second and third rectifying smoothers 12, 22 and 32 in the form of half-wave rectification. While FIG. 3 demonstrates the DC-DC converter provided with three outputs, it may be redesigned to provide DC-DC converters having two, four, five or more outputs. The present invention can be applied to flyback or combined forward and flyback resonant DC-DC converters of multi-output type, without limitation to shown forward resonant types.

What is claimed are:

1. A DC-DC converter of multi-output type, comprising:
first and second switching elements connected in series to a DC power source,
a series circuit of a capacitor, a current resonance inductance and a primary winding of a transformer connected in series between a junction of the first and second switching elements and DC power source,
a control circuit for alternately turning said first and second switching elements on and off to produce a plurality of DC outputs from plural secondary windings of the transformer each through rectifying smoother, and
at least one magnetic amplifier connected in series between each of second or more secondary windings and related rectifying smoothers,
wherein the first DC output produced from the first secondary winding is controlled by adjusting a duty ratio of said first and second switching elements, and
adjustment of reset current to the magnetic amplifier causes to control the DC-outputs from the second or more secondary windings.

2. The DC-DC converter of multi-output type of claim 1, wherein polarity of half-wave rectification is different between at least one of second or more secondary windings and first secondary winding of the transformer.

3. The DC-DC converter of multi-output type of claim 1 or 2, wherein a plurality of DC outputs are produced from said rectifying smoothers in the form of half-wave rectification.

4. The DC-DC converter of multi-output type of claim 1, wherein said first and second switching elements are alternately turned on and off with the drive signals inclusive of predetermined pauses from said control circuit.

5. A DC-DC converter of multi-output type, comprising:
first and second switching elements connected in series to a DC power source,
a first series circuit of first and second current resonance capacitors connected in parallel to said first and second switching elements,
a second series circuit of a current resonance inductance and a primary winding of a transformer connected between a junction of said first and second switching elements and a junction of said first and second current resonance capacitors,
a control circuit for alternately turning said first and second switching elements on and off to produce a plurality of DC outputs from plural secondary windings of the transformer each through rectifying smoother, and
at least one magnetic amplifier connected in series between each of second or more secondary windings and related rectifying smoother,
wherein a first DC output from said first secondary winding is controlled by adjusting a duty ratio of said first and second switching elements, and
adjustment of reset current to the magnetic amplifier causes to control the DC-outputs from the second or more secondary windings.
